(19) United States
(12) Patent Application Publication
(10) Pub. No.: US 2019/0383623 A1
(43) Pub. Date: Dec. 19, 2019

(54) DYNAMIC CONNECTION DETERMINATIONS

(71) Applicant: Ford Motor Company, Dearborn, MI (US)

(72) Inventors: Sudipto Aich, Palo Alto, CA (US); Jeanne Isaacs, Los Altos, CA (US); Jamel Seagraves, Campbell, CA (US)

(21) Appl. No.: 16/009,072

(22) Filed: Jun. 14, 2018

(51) Int. Cl. G01C 21/34; G06Q 10/02; G06Q 10/04

(52) U.S. Cl. CPC G01C 21/3423; G06Q 10/047; G06Q 10/025

(57) ABSTRACT

A provider, such as a transportation management service, can manage transport for a number of riders between various locations. Routes can include at least two segments using the same or different modes of transportation. A customer can select a transportation option for an initial segment, without having to commit to options for other segments of the route. Transportation for those subsequent segments can be automatically booked or suggested at, or during, a time for the journey, such as during travel for the initial segment of the journey. A transportation service can receive confirmation that the rider is on a particular vehicle, determine the estimated time and location of arrival, and determine routing options for the next segment. The service can then automatically book the best option for the rider, or can suggest one or more options for selection or confirmation by the rider.

### BACKGROUND

People are increasingly turning to a variety of different transportation and mobility offerings, including ridesharing and e-biking in addition to conventional public transit offerings such as trains and public buses. Ridesharing can involve riders being allocated vehicles that are dedicated to those riders for a period of time, or being allocated seats on vehicles that will have other passengers riding at the same time. While individually allocated cars can have some benefits, sharing vehicles can reduce costs and provide some certainty as to scheduling. The sharing of vehicles among multiple concurrent riders can have various constraints, however, as riders will want some certainty as to the time of the ride and arrival at the destination, such that flexibility of the routes may be limited. It therefore may be desirable to attempt to balance the economics to the provider of maximizing occupancy and utilization of the vehicles with the convenience and experience offered to the riders.

### BRIEF DESCRIPTION OF THE DRAWINGS

Various embodiments in accordance with the present disclosure will be described with reference to the drawings, in which:

FIGS. 1A and 1B illustrate an example ride request environment in which aspects of various embodiments can be implemented.

FIGS. 2A, 2B, and 2C illustrate an example notification flow indicating automatic booking of a connection or subsequent journey segment that can be generated which aspects of various embodiments can be implemented.

FIG. 3 illustrates an example approach for matching ride requests to vehicle capacity that can be utilized in accordance with various embodiments.

FIGS. 4A and 4B illustrate example origination and destination locations, and routes for serving those locations, that can be determined for a service area over a period of time in accordance with various embodiments.

FIG. 5 illustrates an example system that can be utilized to implement aspect of the various embodiments.

FIG. 6 illustrates an example process for automatically reserving a future connection for a current journey that can be utilized in accordance with various embodiments.

FIG. 7 illustrates an example process for reserving transport for future journey segments that can be utilized in accordance with various embodiments.

FIG. 8 illustrates an example process for automatically reserving one or more segments for a future journey that can be utilized in accordance with various embodiments.

FIG. 9 illustrates an example process for determining routing options for a plurality of ride or transport requests that can be utilized in accordance with various embodiments.

FIG. 10 illustrates an example computing device that can be utilized to submit trip requests and receive route options in accordance with various embodiments.

FIG. 11 illustrates example components of a computing device that can be utilized to implement aspects of the various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches described and suggested herein relate to the providing of transportation between specified locations. In particular, various embodiments provide approaches for determining and selecting from various routing solutions, of one or more modes of transportation, to serve a set of transportation requests. The requests can relate to the transportation of people, animals, packages, or other objects or passengers, from an origination location to a destination location. The requests may also include at least one time component, such as a requested time of departure or arrival. A provider, such as a transportation service, can utilize a routing determination process, for example, to balance various metrics when selecting between proposed routing solutions to serve a set of customer trip requests. One or more optimization processes can be applied, which can vary the component values or weightings of the routing process in order to attempt to improve the options generated and/or selected for each proposed routing solution. A solution can be selected for implementation based at least in part upon the resulting quality scores of the proposed routing solutions.

In at least some embodiments, the routes selected between a point of departure and a point of arrival can include at least two legs or segments, which can be provided by the same or different modes of transportation. A customer can submit a request for transportation between an origin and a destination at, or near, a specified time, and can receive information for traveling options along one or more routes between those locations. In some embodiments, a customer can select one or more options to take for an initial segment of the journey. Instead of also having to select, or commit to, options for other segments along the selected route, the user can have the option of having transportation for those subsequent segments either automatically booked or at least suggested to the user at, or during, a time for the journey, such as during travel for the initial segment of the journey. A transportation service can receive confirmation that the rider is on a particular vehicle or mode of transportation, and can determine the estimated time and location of arrival. The service can then determine the routing options for the estimated time and location to be used for the next segment, which can be more accurate than would have been possible before the commencement of the initial segment. The service can then automatically book the best option (or another determined option) for the rider, or can suggest one or more options for selection or confirmation by the rider. Each segment can be booked based at least in part upon the status of the earlier segment, which can provide for a much more efficient and flexible transportation system. In some embodiments where there are specific travel patterns determined for a given rider, automatic booking can also be used to manage the first segment of the journey as well. Such an approach can be used with different modes of transportation managed by different entities, such as where a customer first uses public transportation along a fixed route and then catches at least one other source of transportation to arrive at the desired destination.

Various other such functions can be used as well within the scope of the various embodiments as would be apparent to one of ordinary skill in the art in light of the teachings and suggestions contained herein.

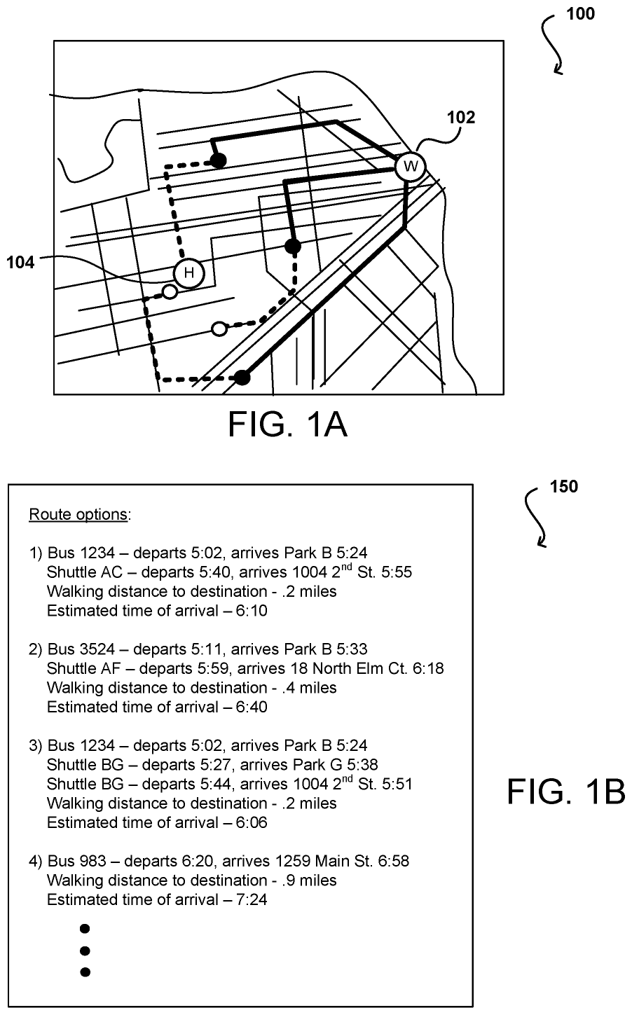

FIG. 1A illustrates an example location 100 in which aspects of the various embodiments can be implemented. In this example, a user can request transportation from an origin to a destination location using, for example, an application executing on a client computing device. Various other approaches for submitting requests, such as by messaging or telephonic mechanisms, can be used as well within the scope of the various embodiments. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. For various embodiments discussed herein a “client device” should not narrowly be construed as a conventional computing device unless otherwise stated, and any device or component capable of receiving, transmitting, or processing data and communications can function as a client device in accordance with various embodiments.

The transportation can be provided using one or more vehicles (or other modes of transportation) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. The rides provided to an individual rider from the point of departure to the point of arrival may also involve one or more vehicles, which may be of the same or different types, for the same or different modes of transportation. For example, in FIG. 1A a customer of a transportation service might want to use the service to obtain transport from a specified origin 102 or point of departure, such as the customer's place of employment, to a specified destination 104 or point of arrival, such as the user's home. Various other types of locations or ways of specifying locations can be used as well within the scope of the various embodiments. There may be modes of transportation offered that use fixed routes (such as trains or public buses), semi-fixed routes (such as shuttle buses), flexible routes (such as rideshares), or complete flexibility (such as e-bikes or scooters), among other such options. While more flexible options, such as ride shares, may provide for the shortest travel times in some situations, they may also come at a higher cost than fixed route options, such as subways or public buses. Further, flexible route options such as rideshares may be subject to traffic congestion or other issues that may introduce additional uncertainty into arrival times, etc.

For at least some of these reasons, customers or riders may choose to take fixed route transportation for at least some of their journey. For example, a customer might take a public bus out of downtown due to the relatively low cost and frequent availability of the buses. These buses can go to one or more stops from which the customer can obtain a connecting transport if needed, or desired, to complete a remainder of the journey. In many instances, a customer might want flexibility in the timing of the bus or initial mode of transport, such as to be able to catch the next available bus along a given route. A customer might also want to be able to select from multiple available routes to obtain additional options. As illustrated in FIG. 1A, there may be a number of bus routes (illustrated using the solid lines) that go from a destination, such as a bus stop near the customer's place of employment, to one or more destinations along substantially fixed routes. The customer may be willing to take any of these routes from the point of origin 102, particularly at rush hour or in inclement weather, etc.

Such an approach can make it difficult for the customer to plan, however, as each option can come with a different time and/or point of arrival. In conventional approaches, a customer can catch one of the fixed transit lines to one of the connection points (illustrated by black dots in the figure) and then once at the connection point, or sufficiently near the connection point, the customer can use an app to obtain a rideshare option, or can utilize their own vehicle, among other such options. These options can be more expensive than other options proposed herein, and in the case of rideshare can be subject to availability and pricing fluctuations. In some embodiments discussed herein, a customer can view potential options for routes that involve multiple legs or segments, which may utilize one or more types of transportation. The user can then select the option that is most desirable or of interest to them, or at least most closely satisfies the customer's current selection criteria, as may include timing and price, among other such options. An example presentation 150 of a set of options is illustrated in FIG. 1B. In this example, the customer is able to view a number of different options that satisfy, or otherwise at least partially match, one or more search criteria submitted by the customer for a future transportation need. As illustrated, the options can include different times of departure near the customer's requested time, that all leave from a specified location. The options include different options for the initial leg, here including different buses that travel at different times and/or to different locations. From those locations, there are different options presented to continue on towards the destination. These include not only different connection options, such as different shuttles, but also include options for walking or biking certain distances, etc. As should be apparent, the number of options can quickly overwhelm a customer, and can also lock the customer in to a fixed schedule or selection once the customer decides on one of these options.

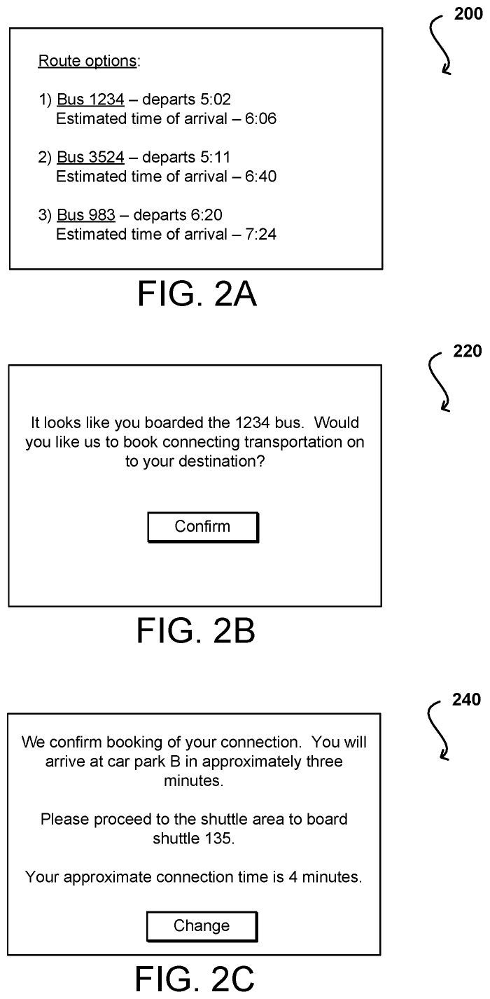

Accordingly, approaches in accordance with various embodiments can provide for the automated booking and/or selection of travel options for a customer, such as is also referred to a rider elsewhere herein. The customer can provide information about a desired journey, such as timing information in addition to information about the origin and destination locations for the journey. The customer can then be provided with one or more options that can be utilized for at least an initial segment or portion of the journey. An example presentation 200 of such content is illustrated in FIG. 2A. In this example, a user can have entered route criteria as discussed, and the system can have determined a set of options for transporting the customer to the target destination. Instead of having the user select information for the entire journey, such as for multiple segments, the system can provide the user with a set of options for the initial segment of the journey. In FIG. 2A, the customer is presented with three different options that include different buses that leave at different times. In some embodiments the customer can select one of those options for the route, while in others the customer can select the journey knowing that they should be able to catch any of those options for completing the journey. In still other embodiments, a customer might select a default option to guarantee a seat, but have the ability to catch (e.g., utilize for transport along the relevant segment) one of the other options if sufficient capacity is available. Various other options can be utilized as well within the scope of the various embodiments.

In various embodiments, a customer can then have at least some amount of flexibility to utilize any of the provided options, or potentially other options in at least some embodiments. In the provided options, all three buses leave from the same location but at different times. The customer can then select to board or utilize the option that is most appropriate for the user's time of arrival at the point of origin. For example, a user might plan to board bus 3524 at 5:11, but might arrive at 5:00 and thus can instead board the 1234 bus. This may come at the same price, but is more flexible in that it reduces the wait time for the user. In many instances, the buses might even go to the same location, such as the same park and ride or same bus terminal, etc. The customer can then indicate the bus that the customer boarded, or such information can be determined automatically. For example, the user might open a corresponding app, such as a transportation application executing on the customer's smartphone. The app might display an option where the customer can, through a tap of a displayed option or other such mechanism, confirm the bus that the customer boarded. In some embodiments the customer might be advised to only confirm once the customer has a seat or otherwise has ensured capacity on the mode of transport. This information can be transported to a transportation service provider system, for example, which can then store the confirmation and use the information to determine any subsequent connections or modes of transportation needed for the journey.

In some embodiments, the information can be determined through customer actions or automatically, among other such options. For example, a customer might have to perform an action when boarding a bus or other mode of transportation, such as to tap a card to a payment device, scan a QR code generated on the transportation app, or perform another action indicating that the customer is boarding that vehicle for transport. In some embodiments the vehicle might include one or more cameras and systems with facial (or other) recognition software that can recognize the customer as the customer boards the vehicle and/or occupies capacity (e.g., takes a seat) on the vehicle. In still other embodiments, the system might utilize sensor information in a customer device (such as GPS or other positioning data) to determine that the customer has boarded a particular vehicle. In some embodiments, the app executing on the device can have access to the position information which can be analyzed, on the device or by a remote server, to determine that the movement of the user corresponds to the movement of the vehicle, based on position, velocity, or other such information, and can determine that the user has boarded the vehicle. Other approaches can be used as well, such as to enable a digital, wireless handshake or other communication between the vehicle and a customer device (e.g., smartphone) to indicate that the customer has boarded or is otherwise utilizing a particular mode of transportation. In at least some embodiments the app executing on the client device can confirm this information to the user, such as is indicated in the example presentation 220 of FIG. 2B. The confirmation indicates the vehicle or transport option that has been determined to be of current use by the customer, which the customer in some embodiments can then confirm or, if necessary, correct. Such confirmation can include other information as well, such as payment information, estimated time of arrival, progress on a map view, etc. In this example, the information also indicates to the user that connecting transportation will be automatically booked or selected for their journey based at least in part upon the transport option that the customer is currently utilizing.

Once a determination is made as to the vehicle or transportation option that the customer has taken or otherwise selected, a routing option system or other such service can then attempt to automatically select and book subsequent transportation for the customer for a remainder of the journey. This can be a similar process as was used to determine the initial transport, using a routing algorithm as discussed in more detail elsewhere herein. In this example, the service can select options to provide to the customer that were determined based on the current transportation selection, or can automatically book the option that most closely matches criteria for the journey, as may have been provided by the user or the service provider, or determined from historical rider data or customer preference data, among other such options. FIG. 2C illustrates an example display 240 of information that can be provided to the customer upon booking of such transportation in accordance with various embodiments. This information can provide confirmation of the automatic booking of at least the next leg of the journey, and can provide additional information as well. This additional information can include, for example, the location of the connection, the time for the connection, the type of vehicle or transport booked, and the like. The information can include other relevant information as well, such as information about the driver, the anticipated route, ratings, etc. The customer in at least some embodiments can then have the option to change or select a different option if desired. This can be at the time of confirmation or at any time before the customer boards the connecting vehicle in at least some embodiments. Further, the automatic booking in at least some embodiments may not be performed near the beginning of the initial journey segment, but may instead be made closer to the end of the segment, such as during a threshold period before the estimated time of arrival or when crossing a geo-fencing boundary or location, in order to ensure that the best connection option is selected, as the actual arrival time may vary based upon factors such as traffic, delays, emergencies, and the like. In some embodiments the geo-fencing or timing may not be based upon actual data for the current vehicle or customer, but may instead be based upon schedule data provided for a public transportation option, among other such options.

As mentioned, the types of transportation booked can vary depending upon factors such as availability, route determination criteria, and customer preference, among other such options. For example, some customers may be willing (or prefer) to take an electronic bike or electronic scooter for at least a portion of the journey, while other customers may only be willing to ride in enclosed vehicles such as cars, buses, or trains. In some embodiments the preferences may vary based on environmental factors, such as rain or the traffic at a particular time of day. A customer can provide their preference information, or the customer preferences can be learned over time, such as by processing customer selection, behavior, and/or review data using machine learning or another such process. This information can then be factored into the route determination and/or optimization algorithms as discussed in more detail elsewhere herein.

Although some of the primary examples discussed herein relate to going from less-flexible to more-flexible modes of transportation, such as going from a public bus to a shared shuttle, it should be understood that routes going to less-flexible modes of transportation can utilize aspects of the various embodiments as well. For example, a train or bus might have assigned seating or a maximum number of spaces available. Even if the user is on a bike or using a ride share, the transportation service can determine the mode that the user is currently using, along with the estimated time of arrival, to automatically book the user on the best connection option, such as the bus that is the first to leave the connection point after the estimated time of arrival, allowing for sufficient connection time in at least some embodiments. In this way, the user can have some flexibility in time of arrival, such as where there is extra traffic or congestion, or where the user wants to stop for a cup of coffee, among other such reasons. Similarly, if the user is making better time than expected then the user can be automatically booked on an earlier option. The time at which the connection is automatically booked can depend in some embodiments upon the mode of transportation, as a rider on a train that is on schedule might have a connection automatically booked at or near the start of a journey, while a customer walking or riding a bike might have a ride booked when the customer is an estimated ten minutes away. The time for auto-booking may also depend at least in part upon the time windows between connection options, such as where buses leave every five minutes versus every thirty minutes. The auto-booking time can also depend in at least some embodiments upon the determined availability, as it may be more desirable to book earlier when there is less capacity in order to improve the odds of being able to book the best option for the particular journey.

Such approaches can be desirable to customers, as the overall experience can be improved. This can be a result of fewer missed connections, shorter wait times, and increased travel flexibility, among other such advantages. The improved customer experience will also benefit the transportation provider, as ridership should increase with respect to other modes of transportation. Such an approach can have further benefit to the transportation service provider, as vehicle utilization should be improved and customers can be routed using options that those customers might not otherwise select on their own, enabling the customers to be spread more evenly throughout the system. Further, the improved flexibility can result in fewer re-bookings, which can reduce costs for the provider, as well as the amount of processing and resource capacity needed to operate the system. Further still, such an approach can help to potentially reduce the number of human operators needed for booking or rebooking of travel, as booking of appropriate options can be handled automatically by the service near the time when the service is needed, such that the options will be more accurate and appropriate for the actual circumstances and environment in which the journey is to be taken.

As mentioned, certain customers may not want to be automatically booked for any or all legs of a journey, and may instead require prior approval. In such cases, one or more recommendations for a connection can be surfaced to the user, which the user can approve or decline, and in at least some embodiments can have the ability to select a new option or enter new or additional criteria for a remainder of the route. In such cases, the customer might see the connection information sooner in the process, such as at a time of starting the journey or boarding the initial vehicle, in order to ensure that the customer receives and approves the connection information. In some embodiments, a notification can be sent to the customer that can cause a customer device to ring, vibrate, or otherwise indicate to the user that a message or notification has been received that requires the customer to view and approve. In some instances a default booking might be made for the customer in case the customer does not respond or confirm in time, such that the customer will at least be able to have an option to finish the ride. In some embodiments the bookings will be held until confirmation time to ensure availability, although in some embodiments other confirmed bookings may take precedence over pending bookings, etc.

As with single ride preferences, there can be customer preferences determined for selecting transportation for journeys requiring multiple segments. For example, a customer might prefer the shortest overall time duration regardless of the number of connections or modes of operation used. Others might prefer comfort, shortest connection times, or minimum number of connections, among others. For some customer, the preferences may vary by direction. For example, a customer might want to take only enclosed vehicles on the way to work, but may be more willing to walk or bike on the way home. Certain customers may also have preferred or required stop locations, or can specify locations or modes of transportation that are not to be used. A customer can also specify specific segments, vehicles, routes, or other aspects that are preferred, required, or not to be selected, etc. Various other options can be specified, such as maximum use of highway versus neighborhood driving, minimum or maximum pricing, minimum or maximum quality of service, etc. Any or all of these and other factors or preferences can be used with a routing selection and/or optimization function or process as discussed and suggested herein. Further, as mentioned at least some of these preferences can be learned for a customer over time.

In some embodiments an entire journey can be automatically booked or suggested to a customer. For example, a customer might leave from work at the same time on most weekdays.

Accordingly, the service could send a notification to the customer as discussed above, but this notification instead could ask the user to confirm booking on the initial segment of the journey. This might be the same transportation option that the customer usually takes, or can be one of the options that are appropriate for the time and location. The user can confirm, select an option, decline, or specify new criteria for this particular time, such as an updated departure time or location. Various other options can be used as well within the scope of the various embodiments. In such a situation, the customer might have to confirm the selections for the subsequent segments of the journey, or the initial confirmation may enable the system to automatically book transport for each segment at a time appropriate based on any factors, or combinations thereof, discussed herein.

In some embodiments, the automatic booking may require the customer to take different actions as well. For example, the customer might be on a train or bus that makes multiple stops. In some embodiments, the transportation options for the next segment may depart from different stops or stations, such that the customer may need to be notified of the appropriate stop at which to catch the connection. If this is to be different from the typical or standard stop for that customer, or is anything other than the last stop, then the customer may need to confirm that the customer has received the instruction and will get off at the appropriate stop. In some embodiments the next segment can be automatically confirmed in response to the customer getting off at that stop, which can be detected by sensor, location, or other approaches such as those discussed and suggested herein. Similarly, the customer can be notified if a better option would require the customer to stay on the current mode of transportation longer and instead get off at a later stop, etc. In some embodiments an application can also have an option where the user can indicate that the user would like to get off at a different stop, get to the destination sooner, or otherwise modify one or more segments. The service can then take this information and determine the best booking option based on the current location and desire of the customer.

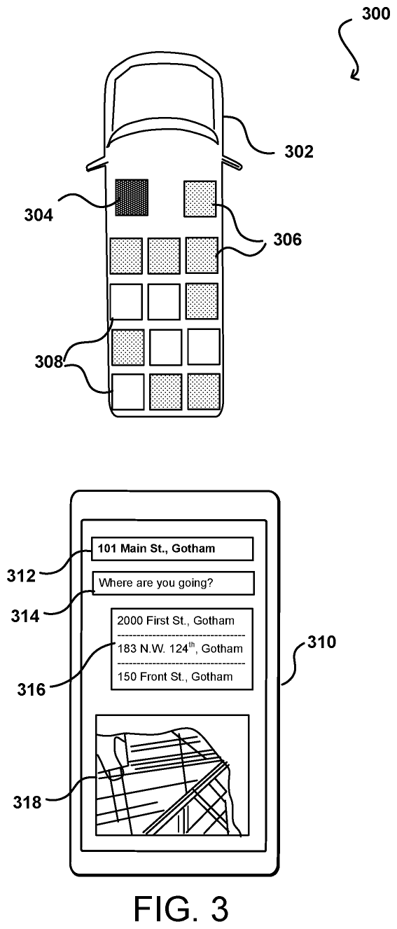

Various systems and services can be used to implement aspects of the invention as discussed and suggested herein. A transport service that provides vehicles that can concurrently be used by more than one rider is often referred to as a “rideshare” service, although as discussed vehicles such as bikes and scooters can be utilized as well which may only serve one customer at a time in at least some embodiments. In one example, a rideshare service can offer routes using at least one type of vehicle 302 that includes space 304 for a driver and seats or other capacity for up to a maximum number of riders, as illustrated in the example configuration 300 of FIG. 3. It should be understood that various types of vehicles can be used with different numbers or configurations of capacity, and that autonomous vehicles without dedicated drivers can be utilized as well within the scope of the various embodiments. Vehicles such as smart bicycles or personal transport vehicles may be used as well, which may include seating capacity for only a single rider or limited number of passengers. For a given vehicle on a given route, a number of available seats 306 (or other rider locations) may be occupied by riders, while another number of seats 308 may be unoccupied. In some embodiments objects such as packages or deliveries may also occupy available space for a ride as well, which can include areas for seating or cargo, or convertible space, among other such options. In order to improve the economics of the rides offered, it can be desirable in at least some embodiments to have the occupancy as close to full as possible during the entire length of the trip. Such a situation results in very few unsold seats, which improves operational efficiency. One way to achieve high occupancy might be to offer only fixed routes where all passengers board at a fixed origination location and off-board at a fixed destination location, with no passengers onboarding or off-boarding at intermediate locations.

A user can request transportation from an origination to a destination location using, for example, an application executing on a client computing device 310. Various other approaches for submitting requests, such as by messaging or telephonic mechanisms, can be used as well within the scope of the various embodiments. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. For various embodiments discussed herein a “client device” should not narrowly be construed as a conventional computing device unless otherwise stated, and any device or component capable of receiving, transmitting, or processing data and communications can function as a client device in accordance with various embodiments.

The transportation can be provided using a vehicle 302 (or other object) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. In this example, a rideshare service offers routes using at least one type of vehicle that includes space 304 for a driver and seats or other capacity for up to a maximum number of riders. It should be understood that various types of vehicles can be used with different numbers or configurations of capacity, and that autonomous vehicles without dedicated drivers can be utilized as well within the scope of the various embodiments. In order to improve or maximize the economics of the rides offered, it can be desirable in at least some embodiments to have the occupancy or utilization as close to full as possible during the entire length of the trip. Such a situation results in very few unsold seats, or little unsold capacity, which improves operational efficiency. One way to achieve high occupancy might be to offer only fixed routes where all passengers board at a fixed origination location and off-board at a fixed destination location, with no passengers onboarding or off-boarding at intermediate locations. As mentioned, such an approach may be beneficial for at least one segment of a given customer journey.

In the present example, a given user can enter an origination location 312 and a destination location 314, either manually or from a set of suggested locations 316, among other such options, such as by selecting from a map 318 or other interface element. In other embodiments, a source such as a machine learning algorithm (or trained neural network, etc.) or artificial intelligence system can select the appropriate locations based on relevant information, such as historical user activity, current location, and the like. Such a system can be trained using historical ride data, and can learn and improve over time using more recent ride and rider data, among other such options. A backend system, or other provider service, can take this information and attempt to match the request with a specific vehicle having capacity at the appropriate time. As known for such purposes, it can be desirable to select a vehicle that will be near the origination location at that time in order to minimize overhead such as fuel and driver costs. As mentioned, the capacity can include a seat for a human rider or sufficient available volume for a package or object to be transported, among other such measures of capacity.

Such an approach may not be optimal for all situations, however, as it may be difficult to get enough users or object providers to agree to be at a specific origination location at a specific time, or within a particular time window, which can lead to relatively low occupancy or capacity utilization, and thus low operational efficiency. Further, such an approach may result in fewer rides being provided, which may reduce overall revenue. Further, requiring multiple users to travel to a specific, fixed origination location may cause those users to utilize other means of transportation, as may involve taxis or dedicated rideshare vehicles that do not require the additional effort. Accordingly, it can be desirable in at least some embodiments to factor rider convenience into the selection of routes to be provided. What may be convenient for one rider, however, may not be convenient for other riders. For example, picking up one rider in front of his or her house might add an additional stop, and additional route distance, to an existing route that might not be acceptable to the riders already on, or assigned to, that route. Further, different riders may prefer to leave at different times from different locations, as well as to get to their destinations within a maximum allowable amount of time, such that the interests of the various riders are at least somewhat competing, against each other and those of the ride provider. It therefore can be desirable in at least some embodiments to balance the relative experience of the various riders with the economics of the rideshare service for specific rides, routes, or other transportation options. While such an approach will likely prevent a ride provider from maximizing profit per ride, there can be some middle ground that enables the service to be profitable while providing (at a minimum) satisfactory service to the various riders or users of the service. Such an approach can improve the rider experience and result in higher ridership levels, which can increase revenue and profit if managed appropriately.

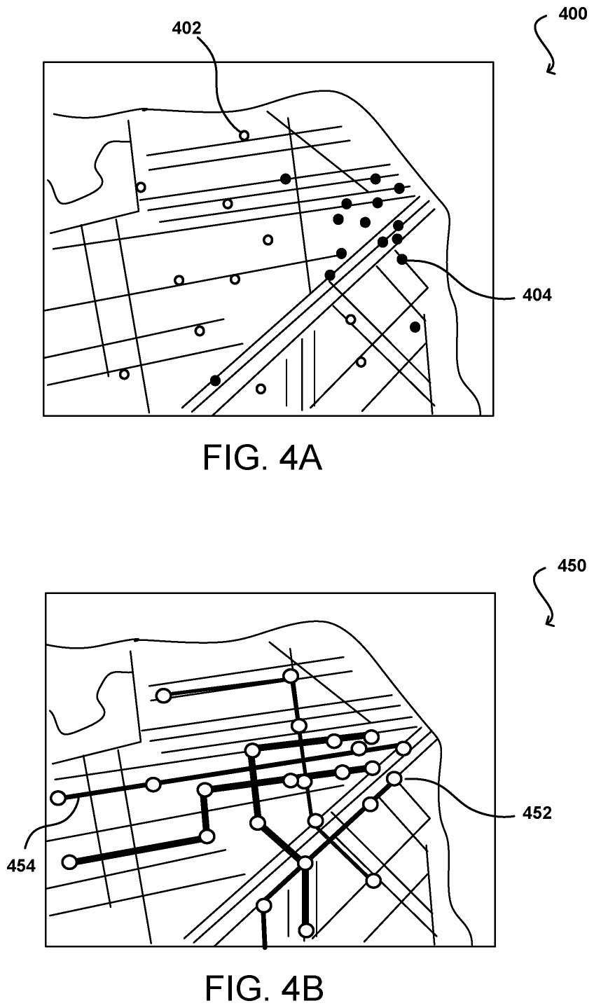

FIGS. 4A and 4B illustrate one example approach that can be utilized to provide such service in accordance with various embodiments. In the example mapping 400 of FIG. 4A, a set of origination points 402 and destination points 404 indicate locations, over a determined period of time, between which one or more users would like to travel. As illustrated, there are clusters of locations where users may want to be delivered, or objects are to be delivered, as may correspond to town centers, urban locations, or other regions where a number of different businesses or other destinations are located. The origin locations, however, may be less clustered, such as may relate to suburbs or rural areas where rider homes may be located. The clustering can also vary throughout the day, such as where people travel from their homes to their places of employment in the mornings, and generally travel in the reverse directions in the evening. There may be little clustering between these periods, or the clustering may be primarily to locations within an urban area. Economically, it may not be practical for a multi-rider vehicle service to provide each person a dedicated vehicle for the determined route, as the overall occupancy per vehicle would be very low. Ensuring full occupancy for each vehicle, however, can negatively impact the experience of the individual riders who may then have to have longer routes and travel times in order to accommodate the additional riders, which may cause them to select other means of transportation. Similarly, requiring a large number of passengers to meet at the same origination location may be inconvenient for at least some of those passengers, who may then choose alternate travel options.

It thus can be desirable, in at least some embodiments, to provide routes and transportation options that balance, or at least take into consideration, these and other such factors. As an example, the mapping 450 of FIG. 4B illustrates a selection of routes 452 that can be provided over a period of time in order to satisfy various rider requests. The routes may not include or correspond to each precise origination and destination location, but can come within an acceptable distance of those locations in most instances. Each route can also be served by one or more vehicles or modes of transportation, each servicing a portion or segment of a given route. There may be situations where origination or destination locations are not served, or served at particular times, where route options may not be available, although in some embodiments a dedicated, limited capacity vehicle may be offered at a determined price, among other such options. Further, while the routes may not enable every vehicle to have full occupancy, the number of passengers per vehicle can be sufficient to provide at least adequate profitability or efficiency to the ridesharing service. The routes 452 provided by such a service may change over time, or even at different times of day, but can have at least a subset of segments that are sufficiently set such that riders can have at least some level of certainty over their commute or travel. While this may not offer the flexibility of other travel options, it can provide certainty of travel at a potentially lower cost point, which can be desirable to many potential users of the service. As mentioned, however, such a service can also provide added flexibility with other ride options, which may come with a higher price to the potential rider.

In order to determine the routes to provide, as well as the vehicles (or types of vehicles) to use to provide those routes, various factors can be considered as discussed and suggested herein. A function of these factors can then be optimized in order to provide for an improved customer experience, or transport experience for transported objects, while also providing for improved profitability, or at least operational efficiency, with respect to other available routing options. The optimization approaches and route offerings can be updated over time based on other available data, as may relate to more recent ride data, ridership requests, traffic patterns, construction updates, and the like. In some embodiments an artificial intelligence-based approach, as may include machine learning or a trained neural network, for example, can be used to further optimize the function based upon various trends and relationships determined from the data as discussed elsewhere herein.

Approaches in accordance with various embodiments can utilize at least one objective function to determine route options for a set of vehicles, or other transportation mechanisms, for one or more regions of service or coverage. At least one optimization algorithm can be applied to adjust the various factors considered in order to improve a result of the objective function, such as to minimize or maximize the score for a set of route options. The optimization can apply not only to particular routes and vehicles, for example, but also to future planned routes, individual riders or packages, and other such factors. An objective function can serve as an overall measure of quality of a routing solution, set of proposed routing options, or past routing selections. An objective function serves as a codification of a desire to balance various factors of importance, as may include the rider's convenience or experience, as well as the service delivery efficiency for a given area and the quality of service (QoS) compliance for specific trips, among other such options. For a number of given origination and destination locations over a given period of time, the objective function can be applied and each proposed routing solution given a score, such as an optimized route score, which can be used to select the optimal routing solution. In some embodiments the routing option with the highest route score will be selected, while in other embodiments there can be approaches to maximize or minimize the resulting score, or generate a ranking, among various other scoring, ranking, or selection criteria. Routing options with the lowest score may be selected as well in some embodiments, such as where the optimization function may be optimized based on a measure of cost, which may be desirable to be as low as possible, versus a factor such as a measure of benefit, which may be desirable to be as high as possible, among other such options. In other embodiments the option selected may not have the optimal objective score, but has an acceptable objective score while satisfying one or more other ride selection criteria, such as may relate to operational efficiency or minimum rider experience, among others. In one embodiment, an objective function accepts as inputs the rider's convenience, the ability to deliver confirmed trips, the fleet operational efficiency, and the current demand. In some embodiments, there will be weightings of each of these terms that may be learned over time, such as through machine learning. The factors or data making up each of these terms or value can also change or be updated over time.

Component metrics, such as the rider's convenience, QoS compliance, and service delivery efficiency can serve at least two purposes. For example, the metrics can help to determine key performance indicator (KPI) values useful for, in some embodiments, planning service areas and measuring their operational performance. Performance metrics such as KPIs can help to evaluate the success of various activities, where the relevant KPIs might be selected based upon various goals or targets of the particular organization. Various other types of metrics can be used as well. For instance, locations for which to select service deployment can be considered, such as where a service area (e.g., a city) can be selected, and it may be desired to develop or apply a deployment or selection approach that is determined to be optimal, or at least customized for, the particular service area. Further, these metrics can help to provide real-time optimization goals for the routing system, which can be used to propose or select routes for the various requests. The optimization may require the metrics in some embodiments to be calculated for partial data sets for currently active service windows, which may correspond to a fixed or variable period of time in various embodiments.

As an example, a rider's convenience score can take into account various factors. One factor can be the distance from the rider's requested origination point to the origination point of the selected route. The scoring may be performed using any relevant approach, such as where an exact match is a score of 1.0 and any distance greater than a maximum or specified distance achieves a score of 0.0. The maximum distance may correspond to the maximum distance that a user is willing to walk or travel to an origination location, or the average maximum distance of all users, among other such options. For packages, this may include the distance that a provider is willing to travel to have those packages transported to their respective destinations. The function between these factors can vary as well, such as may utilize a linear or exponential function. For instance, in some embodiments an origination location halfway between the requested and proposed origination locations might be assigned a convenience score of 0.5, while in other approaches is might earn 0.3 or less. A similar approach may be taken for time, where the length of time between the requested and proposed pickups can be inversely proportional to the convenience score applied. Various other factors may be taken into account as well, as may include ride length, number of stops, destination time, anticipated traffic, and other such factors. The convenience value itself may be a weighted combination of these and other such factors.

Optimizing, or at least taking into consideration, a rider's convenience metric can help to ensure that trips offered to the riders are at least competitively convenient. While rider convenience may be subjective, the metric can look at objective metrics to determine whether the convenience is competitive with respect to other means of transportation available. Any appropriate factors can be considered that can be objectively determined or calculated using available data. These factors can include, for example, an ability (or inability) to provide various trip options. The factors can also include a difference in the departure or arrival time with respect to the time(s) requested by the riders for the route. In some embodiments a rider can provide a target time, while in others the riders can provide time windows or acceptable ranges, among other such options. Another factor can relate to the relative trip delay, either as expected or based upon historical data for similar routes. For example certain routes through certain high traffic locations may have variable arrival times, which can be factored into the convenience score for a potential route through that area or those locations. Another factor may relate to the walking (or non-route travel) required of the user for a given route. This can include, as mentioned, the distance between the requested origin and the proposed origin, as well as the distance between the requested destination and the proposed destination. Any walking required to transfer vehicles may also be considered if appropriate.

Various other factors can be considered as well, where the impact on convenience may be difficult to determine but the metrics themselves are relatively straightforward to determine. For example, the currently planned seating or object capacity utilization can be considered. While it can be desirable to have full occupancy or capacity utilization from a provider standpoint, riders might be more comfortable if they have some ability to spread out, or if not every seat in the vehicle is occupied. Similarly, while such an approach may not affect the overall ride length, any backtracking or additional stops at a prior location along the route may be frustrating for various riders, such that these factors may be considered in the rider's convenience, as well as the total number of stops and other such factors. The deviation of a path can also be factored in, as sometimes there may be benefits to taking a specific path around a location for traffic, toll, or other purposes, but this may also be somewhat frustrating to a user in certain circumstances.

Another factor that may be considered with the rider convenience metric, but that may be more difficult to measure, is the desirability of a particular location. In some embodiments the score may be determined by an employee of the provider, while in other embodiments a score may be determined based on reviews or feedback of the various riders, among other such options. Various factors can be considered when evaluating the desirability of a location, as may relate to the type of terrain or traffic associated with a spot. For example, a flat location may get a higher score than a location on a steep hill. Further, the availability, proximity, and type of smart infrastructure can impact the score as well, as locations proximate or managed by smart infrastructure may be scored higher than areas locations without such proximity, as these areas can provide for more efficient and environmentally friendly transport options, among other such advantages. Similarly, a location with little foot traffic might get a higher score than near a busy intersection or street car tracks. In some embodiments a safety metric may be considered, as may be determined based upon data such as crime statistics, visibility, lighting, and customer reviews, among other such options. Various other factors may be considered as well, as may relate to proximity of train lines, retail shops, coffee shops, and the like. In at least some embodiments, a weighted function of these and other factors can be used to determine a rider's convenience score for a proposed route option.

Another component metric that can be utilized in various embodiments relates to the quality of service (QoS) compliance. As mentioned, a QoS compliance or similar metric can be used to ensure that convenience remains uncompromised throughout the delivery of a route. There may be various QoS parameters that apply to a given route, and any deviation from those parameters can negatively impact the quality of service determined for the route. Some factors may be binary in their impact, such as the cancelation of a trip by the system. A trip is either canceled or performed, at least in part, which can indicate compliance with QoS terms. Modification of a route can also impact the QoS compliance score if other aspects of the trip are impacted, such as the arrival time or length of travel. Other factors to be considered are whether the arrival time exceeded the latest committed arrival time, and by how much. Further, factors can relate to whether origination or destination locations were reassigned, as well as whether riders had to wait for an excessive period of time at any of the stops. Reassignment of vehicles, overcapacity, vehicle performance issues, and other factors may also be considered when determining the QoS compliance score. In some embodiments the historical performance of a route based on these factors can be considered when selecting proposed routes as discussed herein.

With respect to service delivery efficiency, the efficiency can be determined for a specific service area (or set of service areas). Such a factor can help to ensure that fleet operations are efficient, at least from a cost or resource standpoint, and can be used to propose or generate different solutions for various principal operational models. The efficiency in some embodiments can be determined based on a combination of vehicle assignment factors, as may related to static and dynamic assignments. For a static vehicle assignment, vehicles can be committed to a service area for the entire duration of a service window, with labor cost being assumed to be fixed. For dynamic vehicle assignment, vehicles can be brought in and out of service as needed. This can provide for higher utilization of vehicles in service, but can result in a variable labor cost. Such an approach can, however, minimize driving distance and time in service, which can reduce fuel and maintenance costs, as well as wear on the vehicles. Such an approach can also potentially increase complexity in managing vehicles, drivers, and other such resources needed to deliver the service.

Various factors can be considered with respect to a service efficiency (or equivalent) metric. These can include, for example, rider miles (or other distance) planned by not yet driven, which can be compared with vehicle miles planned but not yet driven. The comparison can provide a measure of seating density. The vehicle miles can also be compared with a measure of “optimal” rider miles, which can be prorated based upon anticipated capacity and other such values. The comparison between vehicle miles and optimal rider miles can provide a measure of routing efficiency. For example, vehicles not only travel along the passenger routes, but also have to travel to the origination location and from the destination location, as well as potentially to and from a parking location and other such locations as part of the service. The miles traveled by a vehicle in excess of the optimal rider miles can provide a measure of inefficiency. Comparing the optimal rider miles to a metric such as vehicle hours, which are planned but not yet drive, can provide a measure of service efficiency. As opposed to simply distance, the service efficiency metric takes into account driver time (and thus salary, as well as time in traffic and other such factors, which reduce overall efficiency. Thus, in at least some embodiments the efficiency metrics can include factors such as the time needed to prepare for a ride, including getting the vehicle ready (cleaning, placing water bottles or magazines, filling with gas, etc.) as well as driving to the origination location and waiting for the passengers to board. Similarly, the metric can take into account the time needed to finish the ride, such as to drive to a parking location and park the vehicle, clean and check the vehicle, etc. The efficiency can also potentially take into account other maintenance related factors for the vehicle, such as a daily or weekly washing, interior cleaning, maintenance checks, and the like. The vehicle hours can also be compared against the number of riders, which can be prorated to the planned number of riders over a period of time for a specific service area. This comparison can provide a measure of fleet utilization, as the number of available seats for the vehicle hours can be compared against the number of riders to determine occupancy and other such metrics. These and other values can then be combined into an overall service efficiency metric, using weightings and functions for combining these factors, which can be used to score or rank various options provided using other metrics, such as the convenience or QoS metrics.

Certain metrics, such as optimal rider miles and optimal distance, can be problematic to use as a measure of efficiency in some situations. For example, relying on the planned or actual distance of trips as a quantization of the quality of service provided can potentially result in degradation in the rider experience. This can result from the fact that requiring the average rider to travel greater distances may result in better vehicle utilization, but can be less optimal for users that shorter trips. Optimization of distance metrics may then have the negative impact of offsetting any gains in service quality metrics. Accordingly, approaches in accordance with various embodiments can utilize a metric invariant of the behavior of the routing system. In some embodiments, the ideal mileage for a requested trip can be computed. This can assume driving a specific type of vehicle from the origin to the destination without any additional stops or deviations. The “optimal” route can then be determined based at least in part upon the predicted traffic or delays at the requested time of the trip for the ideal route. This can then be advantageously used as a measure of the service that is provided.

An example route determination system can consider trips that are already planned or being planned, as well as trips that are currently in progress. The system can also rely on routes and trips that occurred in the past, for purposes of determining the impact of various options. For trips that are in progress, information such as the remaining duration and distance can be utilized. Using information for planned routes enables the routing system to focus on a part of the service window that can still be impacted, typically going forward in time. For prorated and planned but not yet driven routes, the optimal distance may be difficult to assess directly since the route is not actually being driven. To approximate the optimal distance not yet driven, the routing system can prorate the total optimal distance in some embodiments to represent a portion of the planned distance not yet driven.

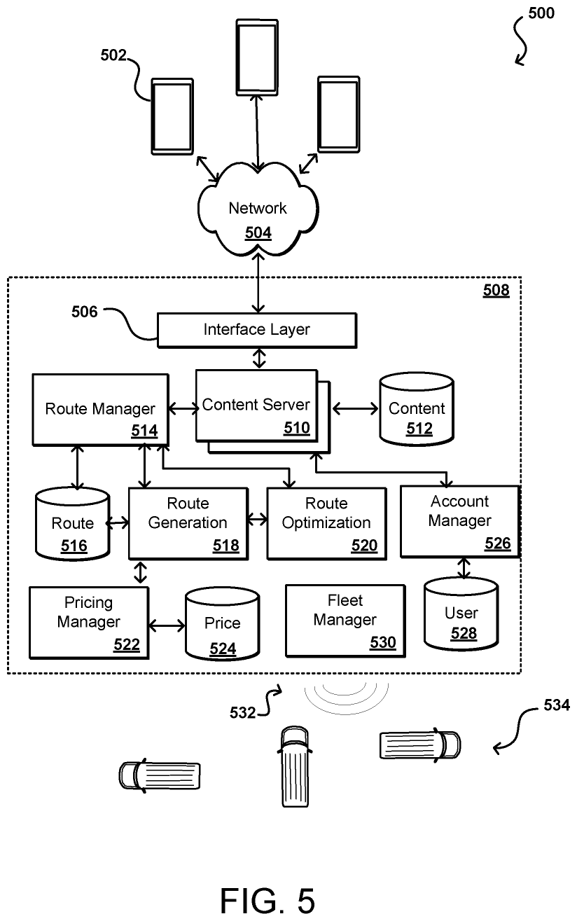

As mentioned, a route optimization system in some embodiments can attempt to utilize such an objective function in order to determine and compare various routing options. FIG. 5 illustrates an example system 500 that can be utilized to determine and manage vehicle routing in accordance with various embodiments. In this system, various users can use applications executing on various types of computing devices 502 to submit route requests over at least one network 504 to be received by an interface layer 506 of a service provider environment 508. The computing devices can be any appropriate devices known or used for submitting electronic requests, as may include desktop computers, notebook computers, smartphones, tablet computers, and wearable computers, among other such options. The network(s) can include any appropriate network for transmitting the request, as may include any selection or combination of public and private networks using wired or wireless connections, such as the Internet, a cellular data connection, a Wi-Fi connection, a local area network connection (LAN), and the like. The service provider environment can include any resources known or used for receiving and processing electronic requests, as may include various computer servers, data servers, and network infrastructure as discussed elsewhere herein. The interface layer can include interfaces (such as application programming interfaces), routers, load balancers, and other components useful for receiving and routing requests or other communications received to the service provider environment. The interfaces, and content to be displayed through those interfaces, can be provided using one or more content servers capable of serving content (such as web pages or map tiles) stored in a content repository 512 or other such location.

Information for the request can be directed to a route manager 514, such as may include code executing on one or more computing resources, configured to manage aspects of routes to be provided using various vehicles of a vehicle pool or fleet associated with the transport service. The route manager can analyze information for the request, determine available planned routes from a route data store 516 that have capacity can match the criteria of the request, and can provide one or more options back to the corresponding device 502 for selection by the potential rider. The appropriate routes to suggest can be based upon various factors, such as proximity to the origination and destination locations of the request, availability within a determined time window, and the like. In some embodiments, an application on a client device 502 may instead present the available options from which a user can select, and the request can instead involve obtaining a seat for a specific planned route at a particular planned time. As mentioned, in some embodiments the bookings or selections can be made by the route manager automatically based on various criteria, among other such options.

As mentioned, in some embodiments users can either suggest route information or provide information that corresponds to a route that would be desired by the user. This can include, for example, an origination location, a destination location, a desired pickup time, and a desired drop-off time. Other values can be provided as well, as may relate to a maximum duration or trip length, maximum number of stops, allowable deviations, and the like. In some embodiments at least some of these values may have maximum or minimum values, or allowable ranges, specified by one or more route criteria. There can also be various rules or policies in place that dictate how these values are allowed to change with various circumstances or situations, such as for specific types of users or locations. The route manager 514 can receive several such requests, and can attempt to determine the best selection of routes to satisfy the various requests. In this example the route manager can work with a route generation module 518 that can take the inputs from the various requests and provide a set of route options that can satisfy those requests. This can include options with different numbers of vehicles, different vehicle selections or placements, different modes of transportation, different segment options, and different options for getting the various customers to their approximate destinations at or near the desired times. It should be understood that in some embodiments customers may also request for specific locations and times where deviation is not permissible, and the route manager may need to either determine an acceptable routing option or deny that request if minimum criteria are not met. In some embodiments an option can be provided for each request, and a pricing manager 522 can determine the cost for a specific request using pricing data and guidelines from a price repository 524, which the user can then accept or reject.

In this example, the route generation module 518 can generate a set of routing options based on the received requests for a specified area over a specified period of time. A route optimization module 520 can perform an optimization process using the provided routing options to determine an appropriate set of routes to provide in response to the various requests. Such an optimization can be performed for each received request, in a dynamic routing system, or for a batch of requests, where users submit requests and then receive routing options at a later time. This may be useful for situations where the vehicle service attempts to have at least a minimum occupancy of vehicles or wants to provide the user with certainty regarding the route, which may require a quorum of riders for each specific planned route in some embodiments. In various embodiments an objective function is applied to each potential route in order to generate a route “quality” score, or other such value. The values of the various options can then be analyzed to determine the routing options to select. In one embodiment, the route optimization module 520 applies the objective function to determine the route quality scores and then can select the set of options that provides the highest overall, or highest average, total quality score. Various other approaches can be used as well as would be understood to one of ordinary skill in the art in light of the teachings and suggestions contained herein.

In at least some embodiments, the objective function can be implemented independent of a particular implementation of an optimization algorithm. Such an approach can enable the function to be used as a comparative metric of different approaches based on specific inputs. Further, such an approach enables various optimization algorithms to be utilized that can apply different optimization approaches to the various routing options to attempt to develop additional routing options and potential solutions, which can help to not only improve efficiency but can also potentially provide additional insight into the various options and their impact or interrelations. In some embodiments an optimization console can be utilized that displays the results of various optimization algorithms, and enables a user to compare the various results and factors in an attempt to determine the solution to implement, which may not necessarily provide the best overall score. For example, there might be minimum values or maximum values of various factors that are acceptable, or a provider might set specific values or targets on various factors, and look at the impact on the overall value and select options based on the outcome. In some embodiments the user can view the results of the objective function as well, before any optimization is applied, in order to view the impact of various factor changes on the overall score. Such an approach also enables a user or provider to test new optimization algorithms before selecting or implementing them, in order to determine the predicted performance and flexibility with respect to existing algorithms.

Further, such an approach enables algorithms to evolve automatically over time, as may be done using random experimentation or based on various heuristics. As these algorithms evolve, the value of the objective function can serve as a measure of fitness or value of a new generation of algorithms. Algorithms can change over time as the service areas and ridership demands change, as well as to improve given the same or similar conditions. Such an approach may also be used to anticipate future changes and their impact on the service, as well as how the various factors will change. This can help to determine the need to add more vehicles, reposition parking locations, etc.

In some embodiments artificial intelligence-inclusive approaches, such as those that utilize machine learning, can be used with the optimization algorithms to further improve the performance over time. For example, the raising and lowering of various factors may result in a change in ridership levels, customer reviews, and the like, as well as actual costs and timing, for example, which can be fed back into a machine learning algorithm to learn the appropriate weightings, values, ranges, or factors to be used with an optimization function. In some embodiments the optimization function itself may be produced by a machine learning process that takes into account the various factors and historical information to generate an appropriate function and evolve that function over time based upon more recent result and feedback data, as the machine learning model is further trained and able to develop and recognize new relationships.

Various pricing methods can be used in accordance with the various embodiments, and in at least some embodiments the pricing can be used as a metric for the optimization. For example, the cost factors in some embodiments can be evaluated in combination with one or more revenue or profitability factors. For example, a first ride option might have a higher cost than a second ride option, but might also be able to recognize higher revenue and generate higher satisfaction. Certain routes for dedicated users with few to no intermediate stops might have a relatively high cost per rider, but those riders might be willing to pay a premium for the service. Similarly, the rider experience values generated may be higher as a result. Thus, the fact that this ride option has a higher cost should not necessarily have it determined to be a lower value option than others with lower cost but also lower revenue. In some embodiments there can be pricing parameters and options that are factored into the objective function and optimization algorithms as well. Various pricing algorithms may exist that determine how much a route option would need to have charged to the individual riders. The pricing can be balanced with consumer satisfaction and willingness to pay those rates, among other such factors. The pricing can also take into various other factors as well, such as tokens, credits, discounts, monthly ride passes, and the like. In some embodiments there might also be different types of riders, such as customer who pay a base rate and customers who pay a premium for a higher level of service. These various factors can be considered in the evaluation and optimization of the various route options.

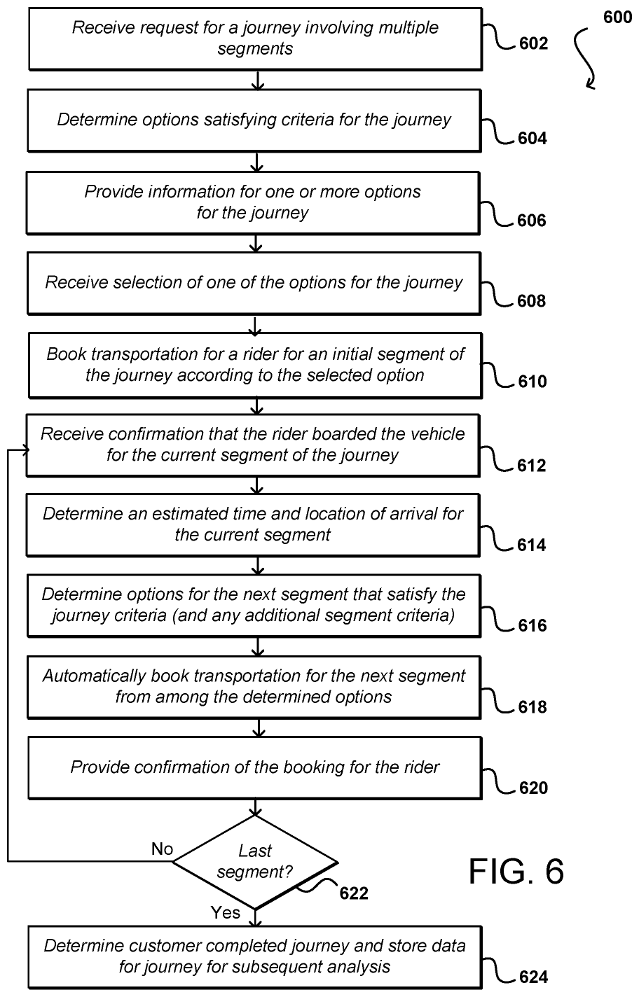

FIG. 6 illustrates an example process 600 for automatically booking a subsequent segment of a journey that can be utilized in accordance with various embodiments. It should be understood that, for this and other processes discussed herein, there can be additional, fewer, or alternative steps, performed in similar or alternative steps, or in parallel, within the scope of the various embodiments unless otherwise stated. In this example, a request is received 602 for a journey that involves at least two segments, or will potentially involve more than one segment for at least some options. The request can be received to a system for an appropriate entity, such as a transportation service provider. As discussed herein, the transport for one or more segments of a journey may be provided by an entity other than the transportation service provider, and can include public entities or other third party entities that may have a contractual relationship with the service provider. A number of such requests can be received from, or on behalf of, various potential customers of the transportation service provider. The requests in this example relate to a future period of time, for at least one specified service area or region, in which the transport is to occur for one or more persons, animals, packages, or other objects or passengers. The requests can be submitted through an application executed on a computing device in many embodiments, although other request mechanisms can be used as well.

In order to determine how to best serve the received request, this example process first determines 604 a set of options satisfying the criteria for the journey. The criteria can include, for example, at least an approximate journey start time and location, as well as a target destination location. Other criteria can be provided or utilized as well, including many of those discussed and suggested elsewhere herein. The process can involve determining available vehicle capacity for serving the requests. This can include, for example, determining which vehicles or transport mechanisms are available to that service area over the specified future period of time, as well as the available seating or other capacity of those vehicles for that period of time. As mentioned, in some embodiments at least some of the seats of the various vehicles may already be committed or allocated to specific routes, riders, packages, or other such options.

Based at least in part upon the various available vehicles and capacity, a set of potential routing solutions can be determined. This can include, for example, using one or more route determination algorithms that are configured to analyze the various origination and destination locations, as well as the number of passengers and corresponding time windows for each, and generate a set of routing solutions for serving the various requests. The potential solutions can attempt to allocate vehicles to customers based on, for example, common or proximate origination and destination locations, or locations that can be served by a single route of a specific vehicle. In some embodiments a routing algorithm can potentially analyze all possible combinations for serving the requests with the available vehicles and capacity, and can provide any or all options that meet specific criteria, such as at least a minimum utilization or profitability, or at most a maximum allowable deviation (on average or otherwise) from the parameters of the various customer requests. This can include, for example, values such as a distance between the requested origination location and a suggested pick up point, deviations from a requested time, and the like. In some embodiments all potential solutions can be provided for subsequent analysis. Further, for multi-segment routing options, the route determination algorithm can take into account possible connection points, as well as the possible routing options from those connection points to the target destination, including the appropriate time windows for each.

The determined routing options can be processed and/or optimized to attempt to identify an optimal routing option, or a set of highest ranked routing options, among other such approaches. Information for one or more of these options for the journey can then be provided 606 to the appropriate destination for communication to the user or intended rider, such as by sending the information for display through a transportation application executing on a smartphone of the user or rider. The information in some embodiments can provide one or more options for the user to select or confirm, in order to confirm a reservation or booking of a seat or other amount of capacity on the selected option for the initial segment of the journey. In other embodiments the information might include options that the rider can utilize without pre-booking, where subsequent segments of the journey will be determined based upon the vehicle or segment option that the rider ultimately boarded or selected. Other approaches can be used as well as discussed herein.

In this example, information indicating a selection (or confirmation) of one of the options is received 608, such as from the transportation app in response to a corresponding user input. As mentioned, the selection can include at least an initial segment for the journey which ensures that the rider will have a seat (or other measure of capacity) booked on the initial transport option of choice, such as a specific train or bus. The transportation for the rider can then be booked 610, reserved, or otherwise allocated for the rider according to the selected option. As discussed, this can include contacting the entity operating the vehicle or route for that segment to request and confirm the capacity. Information for the confirmation can then be provided to the user or rider, through the app, an email message, or another such option.

At a subsequent point in time, confirmation will be received 612 that the rider boarded (or otherwise occupied capacity of) the vehicle for the current segment of the journey. This can include receiving information such as the number of the vehicle and the time of the boarding, in addition to information identifying the user. The information can be provided by the rider, such as by manual entry or confirmation through an application, or can be received from a system on the vehicle, such as where the user is identified to the system through having a code scanned or tapping a device to a payment system sensor, among other such options discussed and suggested herein. As mentioned, in some embodiments the confirmation may be received from a system associated with the transportation service that is able to make the determination using location information transmitted from a device of the rider, among other such options.

Once a determination is made as to the vehicle or other mode of transportation that is transporting the rider along the current segment, an estimated time and location of arrival can be determined 614. This may be based upon a fixed schedule for the segment, or may be based upon more dynamic information such as current location, traffic, or other factors that are used to determine a more accurate time of arrival for the current segment. The determination can be made once for the segment, or can be monitored and updated throughout at least a portion of the segment transit in order to have the most accurate and up-to-date arrival information. Using at least some of this information, another route determination step can be performed to attempt to determine 616 options for the next segment of the journey that satisfy the journey criteria, as well as any additional criteria that may be specific to that particular segment. This can include criteria such as type of vehicle, number of stops, type of seating or capacity, and the like. The segment selection in at least some embodiments also has to fit within the overall journey criteria, such that a segment may not be selected if it would require a third segment for the journey, but the journey criteria required no more than one connection or two total segments (other than potentially walking, etc.). Once the options are determined, including any optimization or ranking, etc., then in this example the optimal, highest ranked, or other preferred option can be determined and transportation for the next segment of the journey can be automatically booked 618 for the rider according to the selected option. The booking will occur while the rider is traveling along the current segment, or has at least boarded the vehicle for the current segment. In this way, the user or rider does not have to guess ahead of time as to the best option, but can instead have the best (or at least an acceptable) option selected dynamically based at least in part upon the transport that the rider utilized for the current segment. This can also take into account factors such as delays and traffic, which the rider might have otherwise not accounted for in the original booking. In at least some embodiments, as discussed, the automatic booking will not take place at the start of the current segment but at a determined point, time, or location, such as when the vehicle reaches a geo-fence location or has reached a threshold time away from the estimated arrival time, among other such options. While booking later in some embodiments may reduce the number of options, it can also help to minimize connection times as well as the need for rebooking due to unforeseen delays. Once booked, a confirmation of the booking can be provided 620, such a through an app on the rider's mobile device so that the rider will know which vehicle or transportation option to use for the next segment. If the next segment is the last, then the process will not need to book any more transport for this journey and can instead store data for the journey for subsequent analysis, or other such usage, after it is determined 624 that the journey has completed.

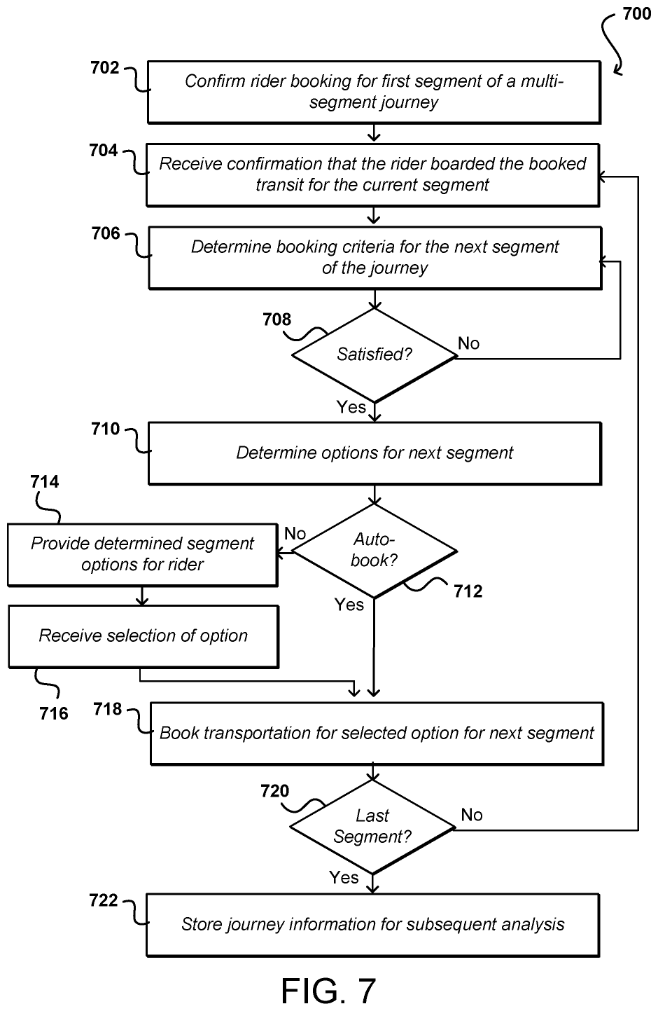

FIG. 7 illustrates an example process 700 for determining transportation for subsequent segments of a multi-segment journey that can be utilized in accordance with various embodiments. In this example, the booking of a rider (human or otherwise) is confirmed 702 for a first segment of a multi-segment journey, using a process such as that discussed with respect to FIG. 6. Confirmation of the booking in this example can cause a record to be created in the system that can be used to manage other aspects of the booking, such as the booking of other segments for the journey at, or around, the time of the journey. In this example, confirmation is received 704 that the rider boarded the booked transit (or another transit option in some instances) for the current segment of the journey, which in this instance would be the initial segment. The confirmation can be in any appropriate form, such as those discussed and suggested elsewhere herein. Once it is confirmed that the rider is on a particular vehicle or mode or transportation for a segment, one or more booking criteria can be determined 706 for booking the next segment of the journey. In this example, the booking criteria can correspond to timing of the booking, such as at the beginning of the current segment, upon receiving confirmation of boarding, when reaching a specific location along the segment, or at a threshold time before estimated arrival, among other such options. If it is determined 708 that the booking criteria are satisfied then the booking process for the next segment can commence, or continue if appropriate.

In this example, options for the next segment can be determined 710 as was done for the previous segment, taking into account any segment-specific criteria in addition to criteria for the overall journey. As discussed above, one or more options can be determined for the next segment of the journey, which may include different modes of transport leaving at different times, among other such options. A determination can also be made 712 as to whether the rider, or corresponding user booking the transportation, has consented to, or otherwise approved, automatic booking of subsequent segments. If not, then one or more options for the next segment of the journey can be provided 714 for review, and a selection of one of those options can be received 716 based on rider preference or other such selection criteria. If automatic booking is permitted then the routing, optimization, or other such algorithm can be used to determine the most appropriate option for the next segment. Once the option to be used for the next segment is determined, either automatically or through user interaction, the transportation for the next segment can be booked 718 through the system. As mentioned, in some embodiments this may involve sending a separate message to a transportation provider for the segment option and receiving confirmation of the booking or reservation of capacity. Confirmation or information for the next segment can be provided to the rider such that the rider is alerted as to the proper transportation option to use for the next segment. If it is determined 720 that there is at least one more segment to the journey then the process can continue. Once the rider is on the last segment, the booking portion of the process can complete and journey information can be stored 722 for subsequent analysis or other such usage.

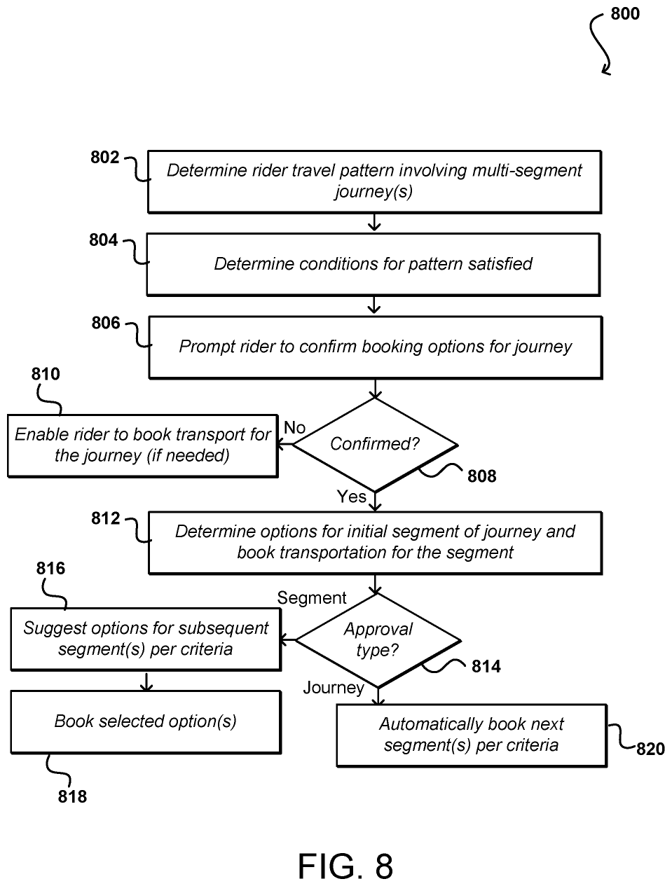

As mentioned, in some embodiments the entire journey may be able to be booked automatically, in addition to individual segment of that journey. One such process 800 is illustrated in FIG. 8. In this example, a travel pattern is determined 802 for a rider, where that pattern involves at least some multi-segment journeys. This pattern can be determined in some embodiments by analyzing data for past journeys taken by the rider, and identifying patterns that have features such as similar start and end times between similar origin and destination locations. The patterns can also include information about the conditions when these patterns typically occur, such as on weekdays for work commutes or on weekends for specific classes or activities, etc. The patterns in some embodiments can be learned through machine learning or other artificial intelligence-based approaches that can benefit from other learned patterns and conditions as well.

Conditions can be monitored over time for a given rider, or there can be various triggers set that are associated with those conditions. In this example it is determined 804 at a point in time that conditions for a specific travel pattern are satisfied. For a daily work commute, for example, this might correspond to a time during the week and near the end of a work day when the rider typically takes a specific route, or one of a set of routes, to reach the rider's home. This might be for any weekday, any weekday that is not a holiday, or any weekday in which the rider took a similar but reverse route to commute to work earlier that day, among other such options. In some embodiments there may be a number of conditions that may be indicative of the need for travel along the pattern, and there may be a weighed combination of these factors used to determine a likelihood or confidence score, for example, which can be compared to a threshold or other such metric to determine when the likelihood is sufficient to warrant proactive booking on behalf of the rider.

In this example, the satisfying of the pattern conditions can cause a transportation system or service to prompt 806 the rider to confirm booking options for the journey. This can include an initial question or notification asking the user whether to proceed with booking for the journey, or at least to provide the user with a reminder and ask if the user would like to initiate the booking process. If it is determined 808 that the user chose not to confirm the booking, or if no response is received before the time for the journey, the rider can be enabled 810 to book his or her own transport for the journey, if needed, or select another transportation option. If a confirmation is received to proceed with the booking, then a set of options can be determined 812 for at least the initial segment of the journey and transportation can be booked for the initial segment. Approaches for determining and reserving transportation for a segment are discussed in more detail elsewhere herein. A determination can be made 814 as to the type of approval or confirmation that was received, or has otherwise been approved for, the rider. If the approval is for the initial segment only, then at an appropriate time the transportation system or service can suggest 816 options to the user to use for the next segment(s) of the journey, such as when the rider is approaching the end of the current segment. The selected option(s) can then be booked 818 for the user. If the confirmation was instead for automatic booking of the entire journey, then the next segment(s) can be booked 820 automatically at the appropriate time(s) using the specified criteria. As mentioned, this can include booking each segment automatically based on the transportation option that was ultimately selected for the prior segment and, in at least some embodiments, the progress or current state of the rider along that prior segment. This process can be performed for any or all segments of the journey, even for segments in which the user is walking or riding a bike or scooter, but location information is available from a smartphone or other such source.

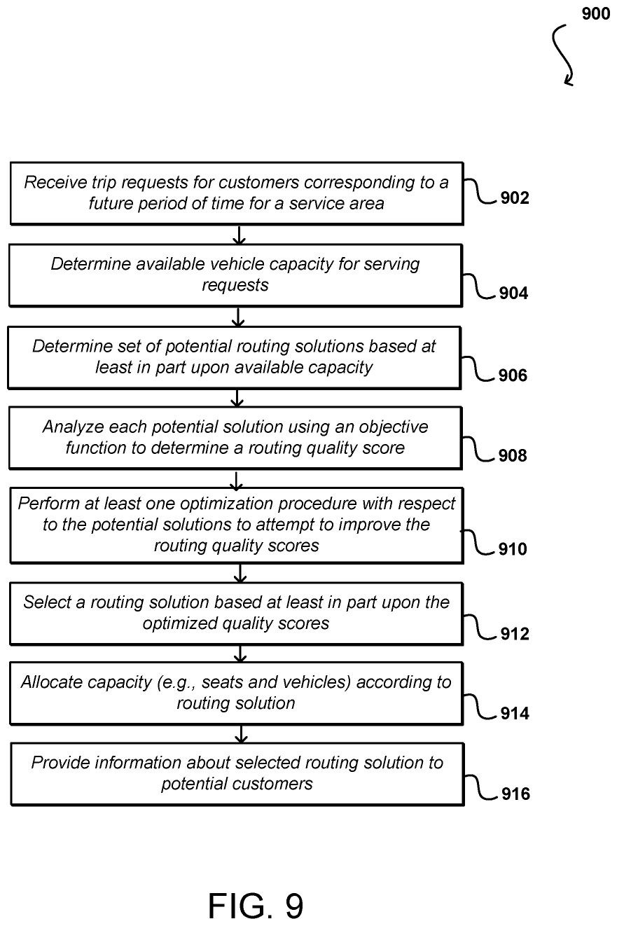

For any of the segments or full journeys, requests can be received for a number of potential riders and the best set of options can be determined that satisfies the customer requests but also satisfies various business requirements as discussed herein. FIG. 9 illustrates an example process 900 that can be used to determine various routing options to serve a set of rider requests in accordance with various embodiments. As mentioned, various other route determination and optimization approaches can be used as well within the scope of the various embodiments. In this example, a number or journey or trip requests are received 902 from, or on behalf of, various potential customers of a transportation service. The requests in this example relate to a future period of time, for at least one specified service area or region, in which the transport is to occur for one or more persons, animals, packages, or other objects or passengers. The requests can be submitted through an application executed on a computing device in many embodiments, although other request mechanisms can be used as well. In order to determine how to best serve the requests, this example process first determines 904 available vehicle capacity for serving the requests. This can include, for example, determining which vehicles or transport mechanisms are available to that service area over the specified future period of time, as well as the available seating or other capacity of those vehicles for that period of time. As mentioned, in some embodiments at least some of the seats of the various vehicles may already be committed or allocated to specific routes, riders, packages, or other such options.

Based at least in part upon the various available vehicles and capacity, a set of potential routing solutions can be determined 906. This can include, for example, using one or more route determination algorithms that are configured to analyze the various origination and destination locations, as well as the number of passengers and corresponding time windows for each, and generate a set of routing solutions for serving the various requests. The potential solutions can attempt to allocate vehicles to customers based on, for example, common or proximate origination and destination locations, or locations that can be served by a single route of a specific vehicle. In some embodiments a routing algorithm can potentially analyze all possible combinations for serving the requests with the available vehicles and capacity, and can provide any or all options that meet specific criteria, such as at least a minimum utilization or profitability, or at most a maximum allowable deviation (on average or otherwise) from the parameters of the various customer requests. This can include, for example, values such as a distance between the requested origination location and a suggested pick up point, deviations from a requested time, and the like. In some embodiments all potential solutions can be provided for subsequent analysis.

In this example process, the various potential routing solutions can be analyzed 908 using an objective function that balances various factors, such as provider efficiency and customer satisfaction, or at least takes those factors into consideration as discussed elsewhere herein. Each potential routing solution that is analyzed using the function, or at least that meets specific minimum criteria, can be provided with a routing quality score generated inserting the relevant values for the solution into the objective function. This can include, for example determining a weighted combination of various quality factors as discussed herein. In some embodiments, the solution with the best (e.g., highest or lowest) quality score can be selected for implementation. In this example, however, at least one optimization procedure is performed 910 with respect to at least some of the potential solutions. In some embodiments the process might be performed for all potential solutions, while in others only a subset of the solutions will go through an optimization procedure, where solutions with a quality score outside an acceptable range may not be considered for optimization in order to conserve time and resources. The optimization process can attempt to improve the quality scores of the various solutions. As discussed herein, an optimization process can attempt to adjust various parameters of the solution, such as to adjust pickup times, stops per route, capacity distribution, and the like. As mentioned, multiple optimization procedures may be applied in some embodiments, where the algorithms may look at different factors or adjustable ranges, etc. Different optimization algorithms may also optimize for, or prioritize, different factors, such as different QoS or efficiency components, profitability, rider comfort, and the like.

After the optimization, at least some of the various proposed solutions may have updated quality scores. Some of the proposed solutions may also have been removed from consideration based on, for example, unacceptable quality scores or an inability to adequately serve a sufficient number of the pending requests, among other such factors. A specific routing solution can then be selected 912 from the remaining solutions, where the solution can be selected based at least in part upon the optimized quality scores. For example, if optimizing for factors such as profitability or customer satisfaction rating, it can be desirable to select the option with the highest score. If optimizing for factors such as cost, it might be desirable to select the option with the lowest score. Other options can be utilized as well, such as to select the score closest to a target number (e.g., zero). As mentioned, other factors may be considered as well. For example, a solution might be selected that has close to the best quality score, but has a much better profitability or customer satisfaction value, or satisfies one or more other such goals or criteria. Once the solution is determined, the appropriate capacity can be allocated 914 based upon vehicles and seating, among other potential options, determined to be available for the determined region at, or near, the future period of time. This can include, for example, determining routes and stops, and assigning vehicles with appropriate capacity to specific routes. The assignment of specific types of vehicles for certain routes may also be specified in the routing options, as there may be certain types of vehicles that get better gas mileage in town and some that get better gas mileage on the highway, for example, such that operational costs can be broken down by types of vehicles as well. In some embodiments specific vehicles might also be due to service for a specific mileage target, which can be factored in as well as other factors, such as cost per mile, type of gasoline, fuel, or power utilized, and the like. Information about the selected routing option can then be provided 916 to particular customers, such as those associated with the received requests. The information can indicate to the users various aspects such as the time and location of pickup, the route being taken, the location and approximate time of arrival at the destination, and potentially information about the specific vehicle and driver, among other such options.

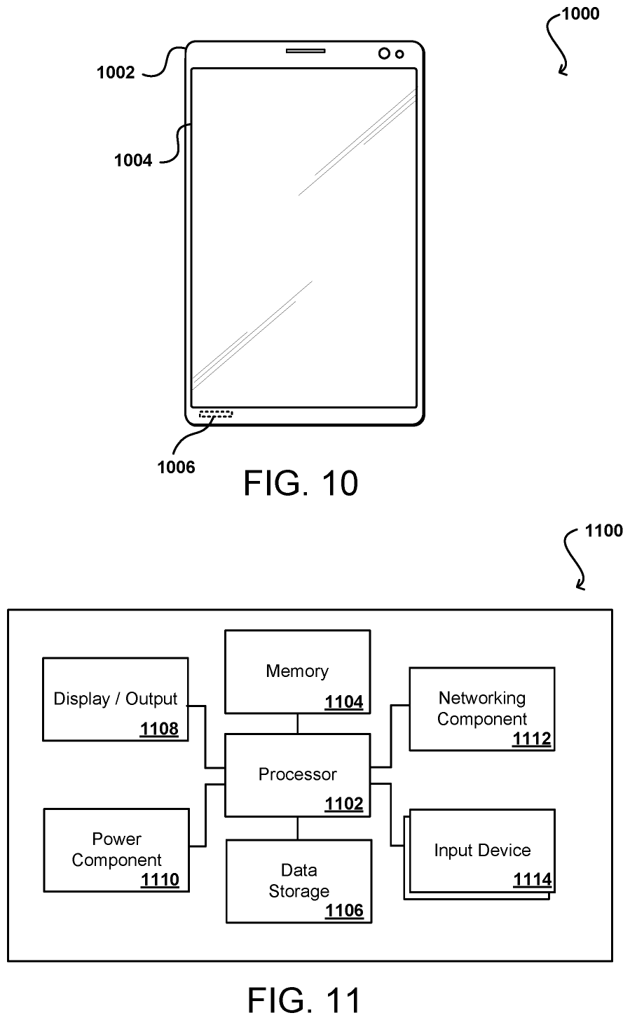

FIG. 10 illustrates an example computing device 1000 that can be used in accordance with various embodiments. Although a portable computing device (e.g., a smart phone or tablet computer) is shown, it should be understood that any device capable of receiving, processing, and/or conveying electronic data can be used in accordance with various embodiments discussed herein. The devices can include, for example, desktop computers, notebook computers, smart devices, Internet of things (IoT) devices, video gaming consoles or controllers, wearable computers (e.g., smart watches, glasses, or contacts), television set top boxes, and portable media players, among others. In this example, the computing device 1000 has an outer casing 1002 covering the various internal components, and a display screen 1004 such as a touch screen capable of receiving user input during operation of the device. These can be additional display or output components as well, and not all computing devices will include display screens as known in the art. The device can include one or more networking or communication components 1006, such as may include at least one communications subsystem for supporting technologies such as cellular communications, Wi-Fi communications, BLUETOOTH® communications, and so on. There may also be wired ports or connections for connecting via a land line or other physical networking or communications component.

FIG. 11 illustrates an example set of components that can comprise a computing device 800 such as the device described with respect to FIG. 10, as well as computing devices for other purposes such as application servers and data servers. The illustrated example device includes at least one main processor 1102 for executing instructions stored in physical memory 1104 on the device, such as dynamic random-access memory (DRAM) or flash memory, among other such options. As would be apparent to one of ordinary skill in the art, the device can include many types of memory, data storage, or computer-readable media as well, such as a hard drive or solid state memory functioning as data storage 1106 for the device. Application instructions for execution by the at least one processor 1102 can be stored by the data storage 1106 then loaded into memory 1104 as needed for operation of the device 1100. The processor can also have internal memory in some embodiments for temporarily storing data and instructions for processing. The device can also support removable memory useful for sharing information with other devices. The device will also include one or more power components 1110 for powering the device. The power components can include, for example, a battery compartment for powering the device using a rechargeable battery, an internal power supply, or a port for receiving external power, among other such options.

The computing device may include, or be in communication with, at least one type of display element 1108, such as a touch screen, organic light emitting diode (OLED), or liquid crystal display (LCD). Some devices may include multiple display elements, as may also include LEDs, projectors, and the like. The device can include at least one communication or networking component 1112, as may enable transmission and receipt of various types of data or other electronic communications. The communications may occur over any appropriate type of network, such as the Internet, an intranet, a local area network (LAN), a 5G or other cellular network, or a Wi-Fi network, or can utilize transmission protocols such as BLUETOOTH® or NFC, among others. The device can include at least one additional input device 1114 capable of receiving input from a user or other source. This input device can include, for example, a button, dial, slider, touch pad, wheel, joystick, keyboard, mouse, trackball, camera, microphone, keypad, or other such device or component. Various devices can also be connected by wireless or other such links as well in some embodiments. In some embodiments, a device might be controlled through a combination of visual and audio commands, or gestures, such that a user can control the device without having to be in contact with the device or a physical input mechanism.

Much of the functionality utilized with various embodiments will be operated in a computing environment that may be operated by, or on behalf of, a service provider or entity, such as a rideshare provider or other such enterprise. There may be dedicated computing resources, or resources allocated as part of a multi-tenant or cloud environment. The resources can utilize any of a number of operating systems and applications, and can include a number of workstations or servers Various embodiments utilize at least one conventional network for supporting communications using any of a variety of commercially-available protocols, such as TCP/IP or FTP, among others. As mentioned, example networks include for example, a local area network, a wide-area network, a virtual private network, the Internet, an intranet, and various combinations thereof. The servers used to host an offering such as a ridesharing service can be configured to execute programs or scripts in response requests from user devices, such as by executing one or more applications that may be implemented as one or more scripts or programs written in any programming language. The server(s) may also include one or more database servers for serving data requests and performing other such operations. The environment can also include any of a variety of data stores and other memory and storage media as discussed above. Where a system includes computerized devices, each such device can include hardware elements that may be electrically coupled via a bus or other such mechanism. Example elements include, as discussed previously, at least one central processing unit (CPU), and one or more storage devices, such as disk drives, optical storage devices and solid-state storage devices such as random access memory (RAM) or read-only memory (ROM), as well as removable media devices, memory cards, flash cards, etc. Such devices can also include or utilize one or more computer-readable storage media for storing instructions executable by at least one processor of the devices. An example device may also include a number of software applications, modules, services, or other elements located in memory, including an operating system and various application programs. It should be appreciated that alternate embodiments may have numerous variations from that described above.

Various types of non-transitory computer-readable storage media can be used for various purposes as discussed and suggested herein. This includes, for example, storing instructions or code that can be executed by at least one processor for causing the system to perform various operations. The media can correspond to any of various types of media, including volatile and non-volatile memory that may be removable in some implementations. The media can store various computer readable instructions, data structures, program modules, and other data or content. Types of media include, for example, RAM, DRAM, ROM, EEPROM, flash memory, solid state memory, and other memory technology. Other types of storage media can be used as well, as may include optical (e.g., Blu-ray or digital versatile disk (DVD)) storage or magnetic storage (e.g., hard drives or magnetic tape), among other such options. Based on the disclosure and teachings provided herein, a person of ordinary skill in the art will appreciate other ways and/or methods to implement the various embodiments.

The specification and drawings are to be regarded in an illustrative sense, rather than a restrictive sense. It will, however, be evident that various modifications and changes may be made thereunto without departing from the broader spirit and scope of the various embodiments as set forth in the claims.

What is claimed is:

1. A computer-implemented method, comprising:
receiving a transportation request for a customer, the transportation request specifying at least an origin, a destination, and a time component;
determining a set of potential routing solutions to serve the transportation request, the routing solutions relating to multi-segment journeys between the origin and the destination;
providing information for a subset of the potential routing solutions for display to the customer, the information including at least time and location information for options for a first segment of each of the multi-segment journeys of the subset, the first segments corresponding to fixed-route transportation options;
receiving confirmation that the customer has boarded a first vehicle operating the first segment of a selected journey of the multi-segment journeys;
determining at least an estimated time and location of arrival of the first vehicle;
determining, using the estimated time of arrival, a potential routing solution for the customer between the location of arrival and the destination for the travel request;
causing, while the customer is aboard the first vehicle for the first segment, a reservation to be automatically generated for capacity on a second vehicle for transporting the customer along a second segment, of the current journey, from the location of arrival towards the destination.

2. The computer-implemented method of claim 1, further comprising:
providing, to a computing device associated with the customer, a notification including information for the second vehicle, the information including at least identifying information for the second vehicle and a time of departure.

3. The computer-implemented method of claim 1, further comprising:
receiving indication of the selected journey from among the subset of potential routing solutions; and
reserving capacity on the first vehicle on behalf of the customer before the customer boards the first vehicle.

4. The computer-implemented method of claim 1, further comprising:
determining that a progress of the first vehicle has reached a booking criterion along the first segment before automatically booking the customer capacity on the second vehicle, the progress relating to at least one of a remaining distance or a remaining time of the first segment before reaching the location of arrival.

5. The computer-implemented method of claim 1, wherein the fixed-route transportation options are provided by at least one public entity unrelated to a transportation service managing the reservation for the customer, and wherein the second vehicle is capable of operating along a variable route.

6. The computer-implemented method of claim 1, further comprising:
receiving confirmation, on behalf of the customer, of the second segment before automatically booking the capacity on the second vehicle.

7. A computer-implemented method, comprising:
determining that a passenger has boarded a first vehicle operating a first segment of a multi-segment journey;
determining at least an estimated time and location of arrival of the first vehicle for completion of the first segment;
determining, based at least in part upon estimated time and location of arrival of the first vehicle, a selected transportation option for a second segment of the journey; and
causing, while the passenger is aboard the first vehicle for the first segment, a reservation to be automatically generated for capacity on a second vehicle for transporting the passenger along the second segment of the multi-segment journey.

8. The computer-implemented method of claim 7, further comprising:
providing, to a computing device associated with the passenger, a notification including information for the second vehicle, the information including at least identifying information for the second vehicle and a time of departure.

9. The computer-implemented method of claim 7, further comprising:
determining one or more routing criteria for the multi-segment journey;
determining a set of potential routing options for the second segment according to the one or more routing criteria; and
determining the selected transportation option for the second segment from among the set of potential routing options.

10. The computer-implemented method of claim 7, wherein the reservation is caused to be automatically generated by a transportation service, and wherein at least the first vehicle for the first segment is operated by a third party other than the transportation service.

11. The computer-implemented method of claim 7, wherein the first vehicle for the first segment operates along a fixed route according to a predetermined schedule.

12. The computer-implemented method of claim 7, further comprising:
determining a travel pattern for the passenger; and
automatically generating a reservation for capacity on the first vehicle in response to one or more conditions for the travel pattern being satisfied.

13. The computer-implemented method of claim 7, further comprising:
determining that a progress of the first vehicle has reached a booking criterion along the first segment before automatically booking the passenger capacity on the second vehicle, the progress relating to at least one of a remaining distance or a remaining time of the first segment before reaching the location of arrival.

14. The computer-implemented method of claim 7, further comprising:
determining that the passenger has boarded a first vehicle by at least one of receiving confirmation from a computing device associated with the passenger, determining a location of the passenger based at least in part upon geo-location data obtained from the computing device, or receiving confirmation that a sensor of the first vehicle verified the presence of the passenger on the first vehicle.

15. The computer-implemented method of claim 7, wherein the second vehicle is one of a shuttle, a bus, a train, a van, a car, a bike, or a scooter.

16. A system, comprising:
at least one processor; and
memory including instructions that, when executed by the at least one processor, cause the system to:
determine that a passenger has boarded a first vehicle operating a first segment of a multi-segment journey;
determine at least an estimated time and location of arrival of the first vehicle for completion of the first segment;
determine, based at least in part upon estimated time and location of arrival, a selected transportation option for a second segment of the journey; and
cause, while the passenger is aboard the first vehicle for the first segment, a reservation to be automatically generated for capacity on a second vehicle for transporting the passenger along the second segment of the multi-segment journey.

17. The system of claim 16, wherein the instructions when executed further cause the system to:
provide, to a computing device associated with the passenger, a notification including information for the second vehicle, the information including at least identifying information for the second vehicle and a time of departure.

18. The system of claim 16, wherein the instructions when executed further cause the system to:
determine one or more routing criteria for the multi-segment journey;
determine a set of potential routing options for the second segment according to the one or more routing criteria; and
determine the selected transportation option for the second segment from among the set of potential routing options.

19. The system of claim 16, wherein the first vehicle for the first segment is operated by a public entity and operates along a fixed route according to a predetermined schedule.

20. The system of claim 16, wherein the instructions when executed further cause the system to:
determine that a progress of the first vehicle has reached a booking criterion along the first segment before automatically booking the passenger capacity on the second vehicle, the progress relating to at least one of a remaining distance or a remaining time of the first segment before reaching the location of arrival.
